(19) United States
(12) Patent Application Publication
(10) Pub. No.: US 2013/0047478 A1
(43) Pub. Date: Feb. 28, 2013

(54) SIGN DISPLAY DEVICE AND SYSTEM FOR INTERCHANGING SIGNS AND BANNERS

(71) Applicant: Harry Chang, (US)

(72) Inventor: Harry Chang, (US)

(21) Appl. No.: 13/452,826

(22) Filed: Apr. 20, 2012

Related U.S. Application Data
(60) Provisional application No. 61/517,497, filed on Apr. 20, 2011.

(51) Int. Cl. G09F 17/00; G09F 1/08; G09F 21/04; G09F 15/00

(52) U.S. Cl. 40/538; 40/604; 40/611.01

(57) ABSTRACT

An improved sign display device and system for interchangeable signs, banners and flags on a variety of surfaces and objects with increased structural simplicity and minimum parts. The sign display device comprises at least one support or frame member, at least one opening in the banner sleeve to expose said support and at least one mounting member. The exposed support or frame member engages one or more mounting members in such fashion as to allow the banner to be mounted on it easily, as well as allow it to be removable and replaceable.

### CROSS-REFERENCE TO RELATED APPLICATION

This application claims the benefit of provisional patent application, application No. 61/517,497 filed 4.20.2011 by present inventor.

### TECHNICAL FIELD

The present invention relates to banners and sign displays and mounting systems for mounting banners, signs, posters and the like on a variety of surfaces and objects.

### BACKGROUND OF THE INVENTION

There are numerous systems known today for mounting banners, signs, posters and the like on walls, poles and the like. Commercial establishments, such as restaurants, service providers and retail outlets commonly use banners and large signs at their places of business to attract customers and notify passersby of specials or other notable matters. There are several factors that drive businesses to us banners and other forms of sign advertising. The two most important reasons being the amount of attention that is garnered due to the visibility of the sign, and the customer-generating potential received for a low initial cost. The relative low cost of banners and other simple signs has provided all types of businesses the means to get their message broadcasted to as many of their potential customers as those who see these signs. But, the low cost of these popular advertising options comes at a price measured in other ways besides the actual cost of the banner. Banners need to be displayed effectively to work best. Unfortunately, due to limitations in current banner designs and mounting systems/methods, effectively displaying banners and signs limited and difficult.

Banners and all type of signage need to be in front of as many people as possible and be eye catching if the business owner wants to maximize the effectiveness of their signage potential to draw customers, as well as to establish their brand to as many passersby as possible. Traditional banners need a flat surface, typically larger than the banner itself, such as a wall of a building. Furthermore, such signs typically require the user to somehow tie the banner up to these structures or worst, to nail or screw down these temporary signage. Because of this, the great majority of banners have grommets, requiring the user to tie a rope or string through most or all of these grommets and then tie the other ends to one of these structures. There are several negative issues that arise from this method. The first is being able to find a highly visible location with the proper conditions and ability to tie down 4, 6 or even 10+ grommets per banner. The second problem is maintaining the level of tension, which is difficult when using tradition string or rope and manually tying the banner.

Banner sag will occur. When this happens, the customer can't read the business' message and the image of the business is lowered due to the non-professionalism of their advertising. The third negative of traditional banners is the amount of labor associated with finding a suitable location and then tying all the ropes/cords to secure the banner. Mounting banners in this manner take up precious time and resources and many times requires more than one person and equipment such as a ladder to complete adequately. Because of this excessive time and effort, banners don't get changed as often as they could or should be. Current, time-sensitive and special messages may not get the chance to reach their intended audience. And when things, like banners seldom change, they become stagnant and no longer noticed.

It is clear that today's banners and temporary signs, although relatively inexpensive, are a slave to how and what they are mounted to, which usually includes sides of building, in between trees, hung from the ceilings or tapped to windows and walls. The banners and temporary signs have an untapped potential that our sign display device and mounting system will unleash. Where current banners are restricted to a limited number of mounting structures and locations, our banner display and mounting system takes the message directly to the customers in fresh new ways.

As previously stated, businesses want to get their message as close to their intended audience as possible. One of the ways they do this is place signage on their glass windows. Almost all window signage is placed on the inside of the glass facing outward. Indoor window signage has several drawbacks. The first is the difficulty of seeing the sign from the outside due to glare and/or blockage by the window itself. Another limiting factor is the size of the window. Traditional signage on the window can only be as high and wide as the window itself, whereas our sign display and mounting method allows for signage to be taller or wider than the window that it's attached to. So, why don't more businesses mount signage on the outside of the glass to get their message closer to all the potential customers passing by? In addition to the limitations and problems mentioned previously, there are problems specific to mounting on windows and glass that greatly limits this preferred signage mounting method.

Furthermore, in the area of business signage and window displays, most businesses have found the existing options/methods lacking in terms of allowing for vehicle signage. There are magnet signs that typically cover only a small area of one or more doors. They are very difficult to see and can cause discoloration of the area of the vehicle that is covered. Vinyl, stickers and car wraps have gained in popularity, but these options can be very expensive and there's no option to quickly, easily and inexpensively change the design of these car decal and car wraps.

The invention presented allows the user the creativity to design a sign, message or attention-generating device in nearly an infinite number of ways, while at the same time giving the users the flexibility to change, almost instantaneously, the sign by removing it from the vehicle or other object/surface and replacing it with another design. Or, the user can completely remove the sign from the vehicle, bringing the vehicle back to its original state: something that current vehicle wraps and similar signage can't accomplish.

Our banner display and mounting system gives freedom to the user to display their message in any legal area without having the limitations of the structures or mounting methods mentioned previously. Our sign display and mounting system allows the user to mount banners/signs on walls, glass, poles, lawns, vehicles or as freestanding. And because our banner display and mounting system uses standard banners and is extremely simple, this new display and mounting system can do all this at a substantially lower cost than existing sign display and mounting systems.

Therefore, there is a definite need for such a convenient display system that allows banners to be installed, removed, or replaced quickly and easily.

Banners and signs preferably are relatively large in size in order to properly attract attention to the presentation. Also, such devices preferably are inexpensive and relatively simple to assemble and mount. Since advertising programs are changed frequently, the banners, signs and posters should also be able to be changed relatively quickly and inexpensively, ideally by as few as one unskilled person.

A number of attempts at making simple and effective banner display devices have been tried. While each represents an advance, they are also each more complicated to construct and less simple to install and/or remove than is necessary. For example, U.S. Pat. Nos. 5,335,889 to Hopkins et al.; 5,263,675 to Roberts et al.; 5,428,913 to Hillstrom; 3,310,899 to Hart et al.; 3,609,894 to Miller; 3,726,035 to Bower et al.; and 3,675,356 and 3,495,346 to Gilmoure all involve banner suspension systems requiring access to the upper end of the banner and therefore some ladder or lift for access during installation. The systems themselves are relatively complicated and permanent, requiring somewhat complex work to replace or remove.

Another attempt is shown in U.S. Pat. No. 3,581,420 to Mollet et al., involves a pole sign setup in which the upper end of a pole sign is hung from simple hooks attached to a pole support member. Again, hanging of the pole sign thus requires access to the upper end of the sign, as for example by means of a ladder or hydraulic lift.

U.S. Pat. No. 4,730,803 to Hillstrom involves a grounded pole banner which reduces the need for ladders or hydraulic lifts but relies upon a relatively complicated track system secured to the side of a pole support member.

Because banners are ideally held taut for optimal display effectiveness, they most commonly either require complicated and expensive frame and mounting systems or they require suspension using rope or string to be attached and tied to the multiple grommets along most banners perimeter. The multiple connection points and labor intensive nature require to secure these banners make it difficult for quick and easy removal and replacement. Furthermore, banners with multiple rope connections though its grommets is not ascetically pleasing. Also, banners mounted in this fashion tend to sag and lose tautness, further decreasing its effectiveness as an advertising tool and can be detrimental to the business' image to have sagging banners displayed, they act like sails

Thus although several systems have been disclosed, there remains a need for a simple, secure, and effective method of suspending and displaying banners, signs, flags, and other advertisements. It is an object of the present invention to provide an improved banner and sign mounting system. It is another object of the present invention to provide a banner and sign mounting system which is relatively inexpensive to manufacture and assemble, and is relatively easy to change or replace.

It is a further object of the invention to provide a banner and sign mounting system which has a minimum of parts and components. Another objective of the present invention is to provide a banner and sign mounting system which can be used by unskilled personnel and provides a mounting structure which is relatively inconspicuous and does not detract from the building or pole when the banner or poster is not in place.

There is a further need for systems which allow easier installation, removal and replacement of banners for displaying during sales, promotions, special occasions, etcetera. There is still further need to for a interchangeable banner mounting system that allows for the same banner to be mounted to more than one surface or object with zero or minimal changes being made to said banner prior to a change in banner mount location or banner display apparatus. There is also a need for a simple and effective system to hold the banners taut while providing a means for the banner to diminish the impact of wind-generated force.

These and other objects, features and benefits of the present invention will become apparent from the following description, when taken in connection with the accompanying drawings and appended claims.

### DISCLOSURE OF THE INVENTION

A new signage system and method to display and attach signs and/or displays, whether for attention-grabbing, advertising or other communication purposes, in a new, quick, easy and novel way to a variety of surfaces including: glass, vehicles and other objects is presented here. One of the preferred embodiments of this invention is to use banner and display devices with business store front windows and on vehicles such as cars, vans, buses and trucks. Another novel embodiment of this invention is the ability of this invention to be attach to a vehicle and then be easily removed and re-attached to a business store front, all within seconds. This new and easy device and system gives the users a host of message and display options that did not exist before.

A key feature of this invention is the ease of attaching and then removing signs and displays from a store window and/or vehicle due to a main component of this invention: the display device attaching unit, and how it connects the banner/sign to the desired surface and/or object. This sign display device and mounting method is first mounted on the surface of an desired objects, such as a store front window, a vehicle window or a concrete wall, then the unique invention banner and mounting system may be mounted to the sign display device and mounting method, which is of course already attached to the object which the user wanted the sign to be displayed on. The sign can therefore be dismounted from the sign display device and mounting method, which will have the same desired effect as removing the display from the wall or object. The sign display device and mounting method can and will most of the time be semi-permanently or permanently mounted to the wall or object. This will allow the banner to be attached and removed to the wall without having to re-attach the sign display device and mounting method to the mounting surface each time the sign is removed.

Another feature in this invention that is not currently available is the ability of this invention to attach signs of varying sizes to a vehicle. This invention can attach signs much smaller than the vehicle window, such as a 4 inch×4 inch ‘Baby on Board’ sign, or span covering multiple windows, or even a sign that's larger than the car itself. The sign can be shaped in an infinite number of ways, such as a cupcake, pizza, geometric shapes, words or human/animal shapes. This invention can be designed to be the approximate size of one or more windows of various vehicle makes and models, i.e. approximately the exact size to cover the front and rear windows of a Mercedes Benz ML350. This invention allows signs and displays that can be two or three dimensional on both a stationary and/or mobile vehicle base. Different embodiments may be used for either a stationary and/or moving vehicle.

In the area of business signage and window displays, most businesses have found the existing options lacking in vehicle signage. There are magnet signs which typically cover only a small area of one or more doors and very difficult to see, it also can cause discoloration of the area of the vehicle that covered. Vinyl, stickers and car wraps have gained in popularity but these options can be very expensive and there's no option to quickly, easily and inexpensively change the design of these car decal and car wraps.

The invention presented allows the user all the creativity to design a sign, message or attention generating device in a nearly infinite number of ways, but it also give the users the flexibility to change, almost instantaneously, the design by removing it from the vehicle or other object/surface and replacing with another design. Or the user can remove the sign from the vehicle, bring the vehicle back to its original state which vehicle wraps and similar signage can't do.

Our invention adds an exponential level of flexibility and options that allow the user to deliver to his potential customer and/or audience targeted, time sensitive messages and offers that other existing signs and signage systems can't do. A restaurant owner can now easily display and change specials for breakfast, lunch and dinner in only a few moments with our invention. Another situational example: businesses can display a 50% discount on all items purchased on Tuesdays, then change the sign to a senior discount sign on Wednesday. This invention's options for users are limitless.

This invention can be one or more components. The attaching mechanism/design being one with display device, would be considered one piece to one or more Display Device Attaching Units (sign display device and mounting method) attached to the car window and/or glass section of a business window. The signage and/or display can then be connected to the sign display device and mounting method on the vehicle and/or glass of a business. One of several attaching options will hold the signage and/or display in place but will still allow the user to easily remove the signage and/or display with their hands or with tools specifically designed for the system by as few as one person.

Because our invention allows for signage and displays to be mounted inside or outside the vehicle and/or business, preferably on one or more outside windows, this invention, can be used so as to be seen, and draw attention all the way up to 360 degrees respective of the window or wall it is mounted on. Businesses will take advantage of this by mounting signs that are not just flat, but also signs that are curved or that have 3D design elements, like rotating displays shaped like a bottle of beer. The attention grabbing sign and/or display can and will be seen by a greater number of people compared to old signs that are pressed against a window. This invention being outside the glass will attract more attention. Attention is usually something businesses seek. The more attention the business gets, the higher the chance that those people convert from observer to paying customer.

In retail, specifically the physical area of business window and glass signage (which comprises a large area of the store or retail front) is very rarely ever used to its full potential. Most glass or window signs are restricted to using stickers, suctions or rope/other cumbersome, time-consuming and limiting systems to attach the signs/message. And almost all window ads and displays are on the inside of the window. Our invention allows the business owner to easily attach, connect and/or mount signage and displays to the outside (or inside) of a glass wall or other material structure. Our invention will just as easily allow the user of our invention to take down, remove and/or change the signage and displays from their glass wall and/or window front.

In its most basic form, the banner apparatus aspect of the INVENTION provides a banner support assembly for holding a banner in a display position, the support assembly comprising a support member, a mounting members, a banner display device mounted to or to be placed on a variety of surfaces or objects that retains a banner and to hold the banner spread out for display, typically in a flat or quasi-flat (e.g., a smoothly curved) condition for viewing or reading. The support member, which is exposed through the openings of the banner sleeve.

Accordingly, it is an object of the INVENTION to provide a simple, secure, and effective means for suspending, displaying and interchanging banners, signs, posters, flags, and other large means for exhibiting information on a variety of surfaces and objects such as, but not limited to, glass windows, walls, fences, railings, vehicles, lawns and other forms of free standing displays. It is a further object of the INVENTION to provide such systems to allow for the easy installation, removal, and replacement of such banners for viewing in as little as a few seconds, by as few as one unskilled person. It is further an object of the INVENTION to provide a simple, secure, and effective means for maintaining tension on banners, flags, and other large means for exhibiting information, with some embodiments providing a means to spill wind and diminish the force generated by the wind.

The INVENTION provides such a system. The sign display device and mounting method represents a novel and improved banner display device for displaying easily exchangeable and interchangeable banners, signs, flags, posters and other means for exhibiting information with extreme structural simplicity and a minimum of parts. In general, the banner display device according to the sign display device and mounting method comprises at least one support or frame member, at least one opening in the banner sleeve to expose and provides access to said support and at least one mounting members or mounting apparatus. The exposed banner supports or frame members engages one or more mounting members and or banner display devices in such fashion as to allow, including the banner mounted on it, to become easily mountable, removable, and replaceable. One embodiment is where the banner itself is held between two parallel frame or support members that have been inserted into the banner sleeves or pockets along the perimeter of the banner. Along the perimeter of the sleeve, there are one or more areas, where the banner material has been slit open or removed to expose the frame member. The exposed frame members areas is where said banner will be mounted in a fixed position to a banner display device, and the other frame member is mounted on a moveable mount that is tensioned and held taut by an elastic member or other means of tension. When the banner is subject to wind loads, there may be an elastic member that allows the frame member mounted on the moveable mount to move toward the fixed frame member, thus spilling the wind, reducing the effective area of the banner subject to the wind, and thus diminishing the force on the banner generated by the wind. In another embodiment, the banner display device maybe mounted to a wall, vehicle or other object where the display apparatus does not require an elastic member to increase tension and or diminish the force generated by the wind.

Perpendicular removable attachable frame members has first and second ends, each of which is adapted to engage one of said mounting members, and the first and second mounting members disposed upon the support member at a distance from each other sufficient to allow the mounting members to be simultaneously and releasably engaged by the brace ends, such that said brace may be supported on said support member and thereby hold said banner in a display position. The mounting and removal of banners from a structures of this type, and in particular of each of the types described herein, in the manner herein described, is remarkably simple. Yet the system provides a very secure mounting well adapted to the efficient display of banners, etc. Moreover, by supplying a banner support assembly with a series of two or more braces, each with an attached banner, the replacement or rotation of banners and their associated messages, etc., may be very quickly and easily accomplished.

The banner display device apparatus also provides a means to hold the banner taut and to spill wind loads. The banner support assembly comprises a pair of frame members which attach to the banner on opposite sides and hold it in display position. A first frame member is attached to brace in a fixed position, and a second frame member is attached to a moveable mount that moves in a channel in the brace. The banner is tensioned and held taut by an elastic member that draws the moveable mount and second frame member away from the first frame member. Wind loads on the banner are relieved by the deformation of the elastic member and the movement of the moveable mount and the second frame member toward the first frame member.

A preferred embodiment of the apparatus aspect of the sign display device and mounting method comprises at least one formed mount with a coupling structure to removably retain the brace and the banner support assembly mounted to the brace. At least one formed mount is attached to the support structure.

The banner support apparatus of the preferred embodiment of the apparatus aspect of the sign display device and mounting method comprises holding the banner between two parallel frame members. The first frame member is attached to the brace, and the second frame member is attached to a moveable or slidable mount that moves along the brace. An elastic member is attached at one end to the moveable mount and the other end is attached to the brace such as to draw the second frame member away from the first frame member and thus tension and hold the banner taut. The degree of tension on the banner is controlled by the characteristics and location of the elastic member, which is selected to hold the banner taut while allowing the banner to respond to wind loads. Under wind loading, the force of the wind on the banner increases the load on the elastic member which stretches and allows the second frame member to move toward the first frame member, thus spilling wind and reducing the effective area of the banner subject to the wind.

As will appear from the disclosure herein and in the Figures, banner display devices according to the sign display device and mounting method provide an extremely simple, secure, and effective means for suspending and displaying banners, flags, and other large forms of exhibiting information. They also provide systems which allow for the easy installation, removal, and replacement of banners for viewing.

### BRIEF DESCRIPTION OF THE DRAWINGS

FIG. 1-FIG. 6 are views of said banners

FIG. 7 is front perspective view of the one embodiment of said banner display device.

FIG. 8. 3a and 3b are schematic front perspective views of the

[symbol]

FIG. 4 is a front view of the banner

FIG. 5 is a perspective view

### REFERENCE NUMBERS

40 Banner
42 Grommets
44 Double sided adhesive pad
45 Banner frame member
46 Attachable frame member mounts
47 Banner member mount
48 Banner member mount grip
49 Releasable no stick cover
50 Perpendicular brace member
52 Perpendicular brace member tensioning means
55 Banner Channel, Banner Sleeve
60 Banner Openings
61 Rigid Sign opening
62 Rigid sign
63 Sign Support member
64 Sign Support member coupling section
65 Sign support mount
66 Sign support mount, coupling section
67 Sign Support member release grip
70 Glass window
71 Window Frame, Window Ribs
72 car window
75 Elongated Banner Display mounting device
78 Gripper member
79 Suction
80 Screw mounts
85 Car
87 Magnets
90 wall
91 Banner frame member opening
92 Rope or string
93 Banner frame member mounting facilitators
94 Removably attachable frame member mounting facilitators
95 Banner display device with support assembly
96 Banner support base
97 Elastic connecting member
98 Banner support base hole with channel to accept display device support assembly
100 Banner display device's fixed attachment points

Turning now to the drawings, the sign display device and mounting method will be described in a preferred embodiment by reference to the numerals of the drawing figures wherein like numbers indicate like parts.

FIG. 1 is a frontal view of a banner 40 with multiple grommets 42.

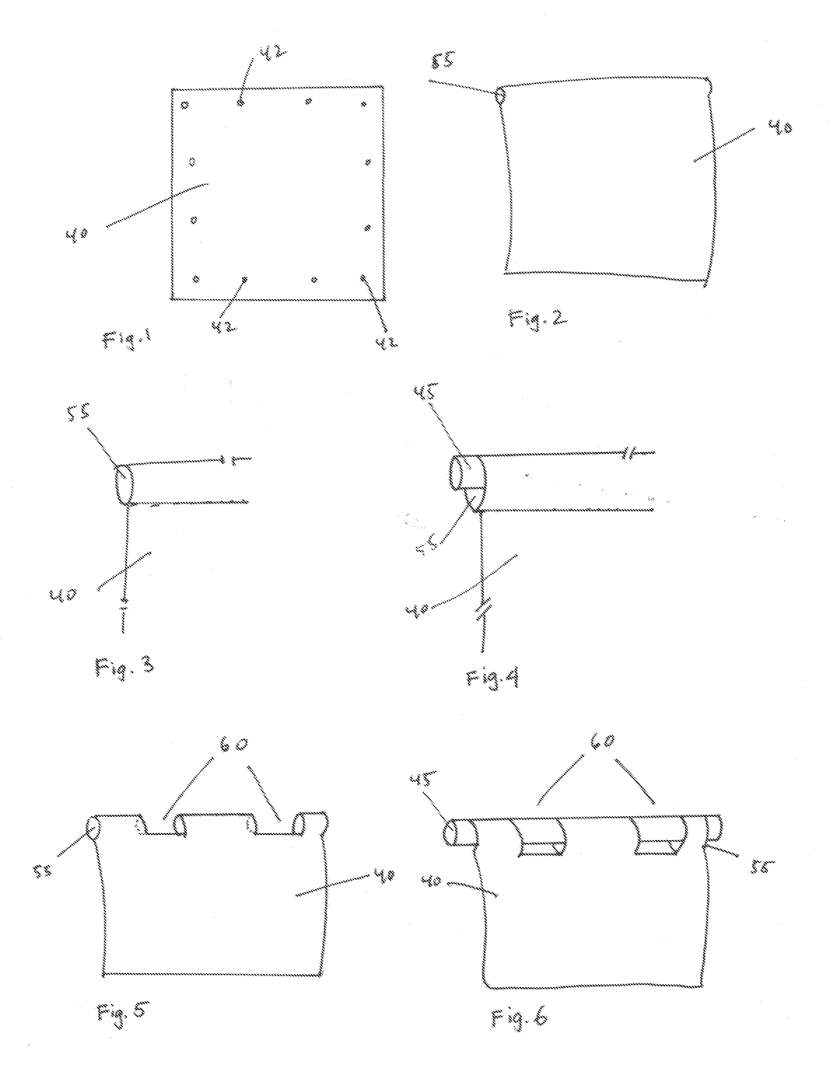

FIG. 2 is a frontal view of a banner 40 with banner channel 55

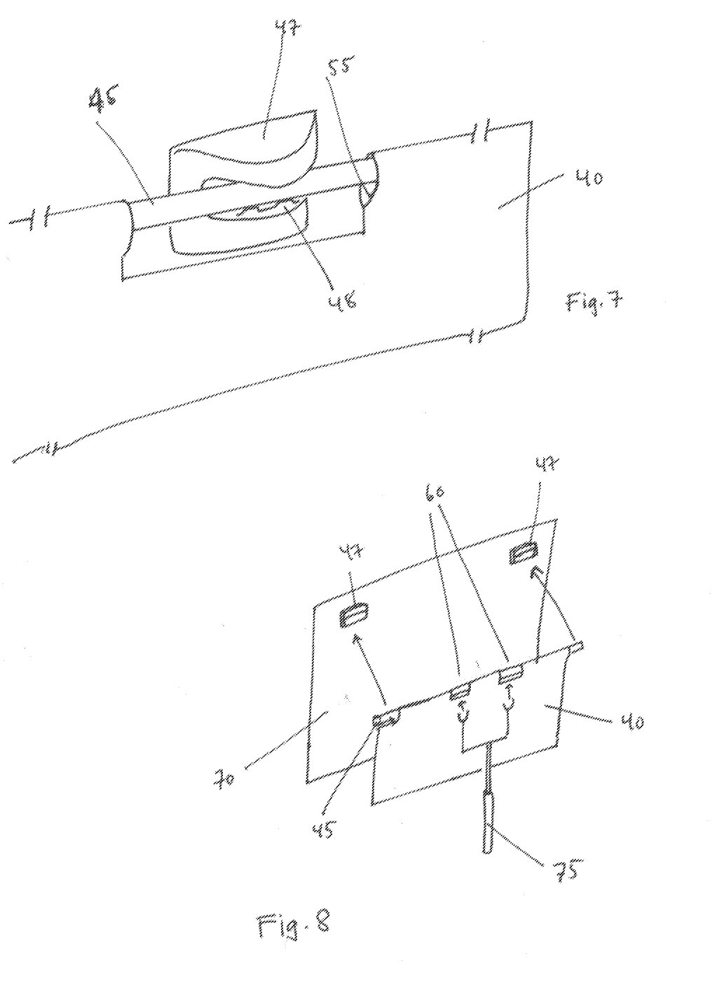

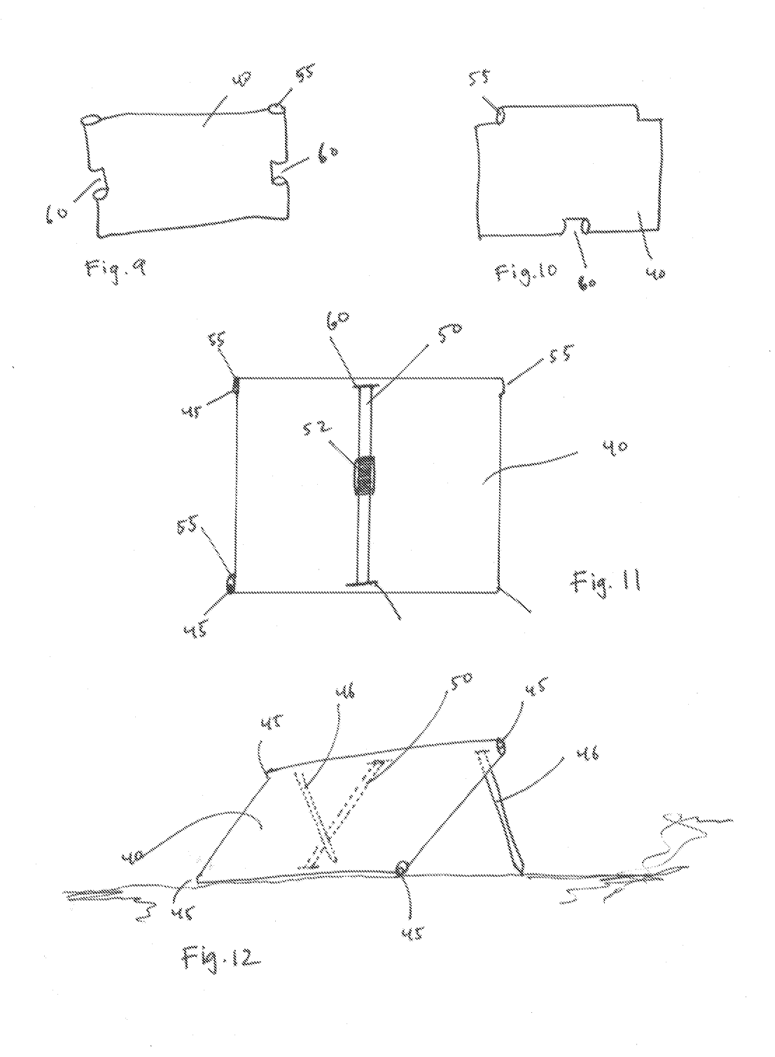

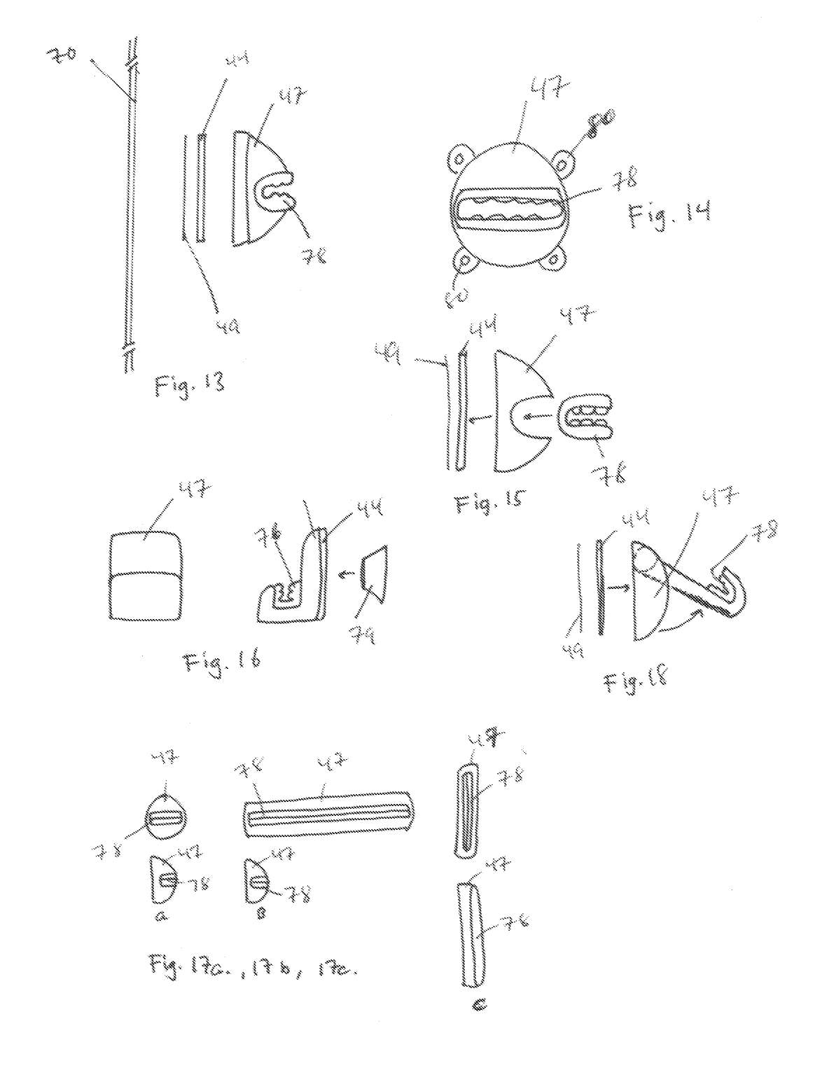

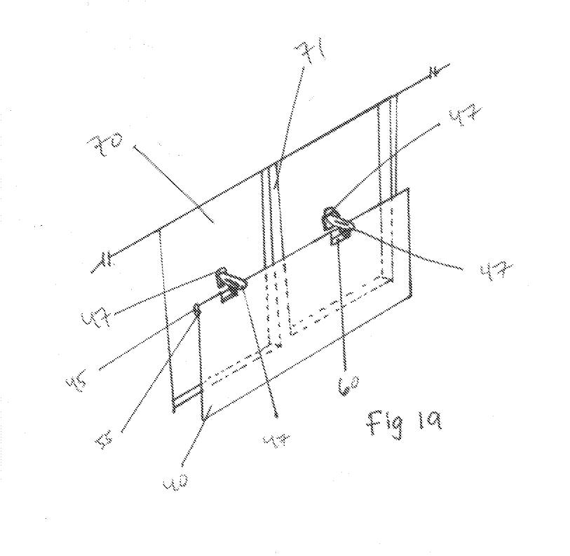

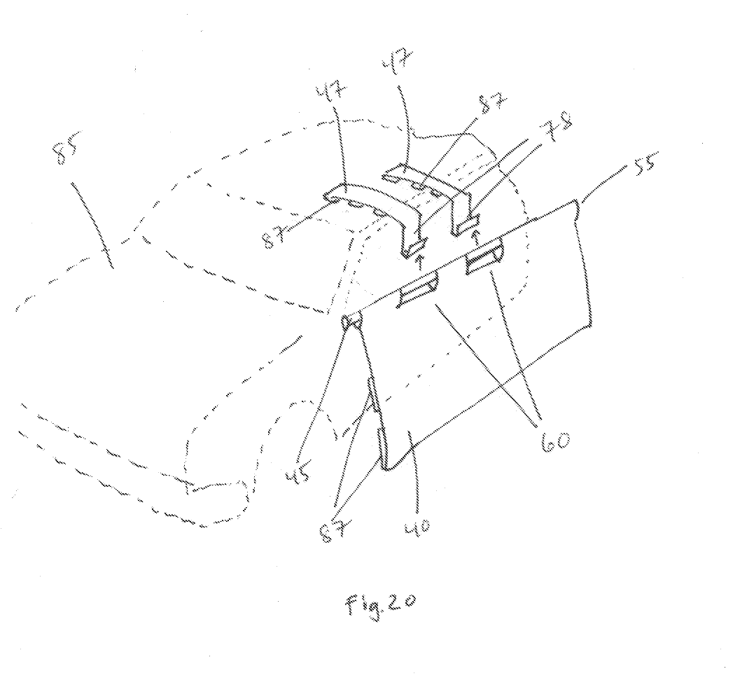

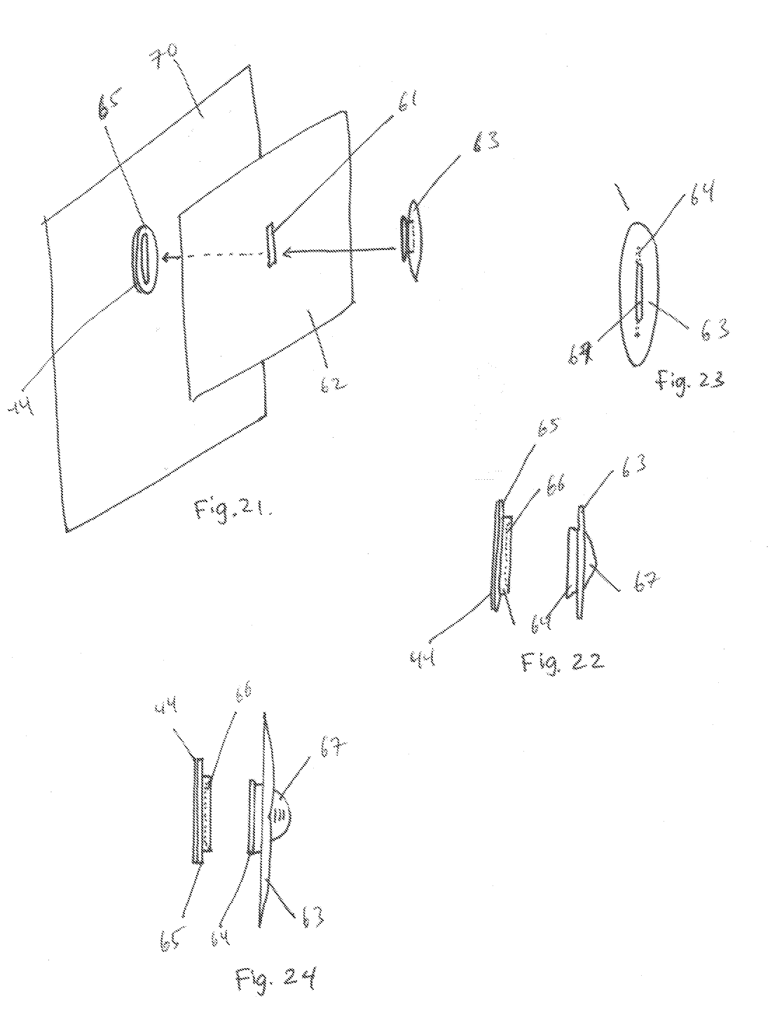

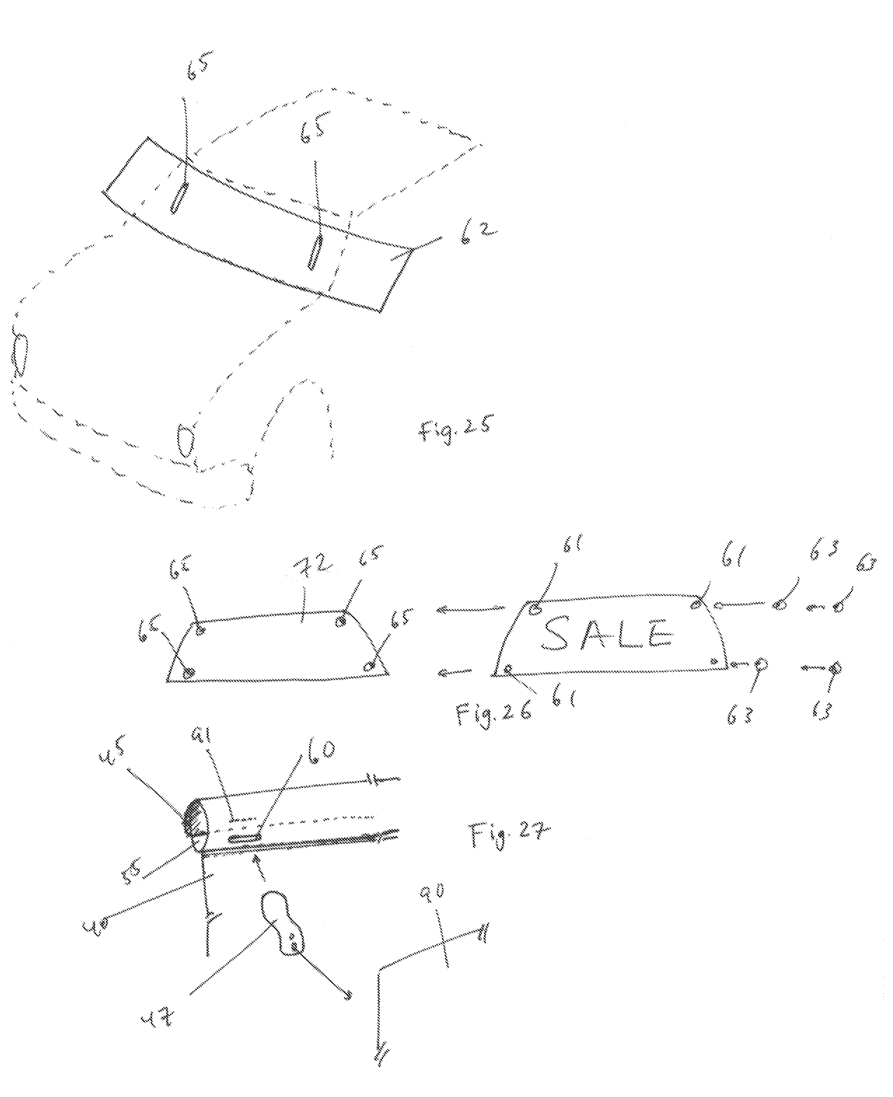

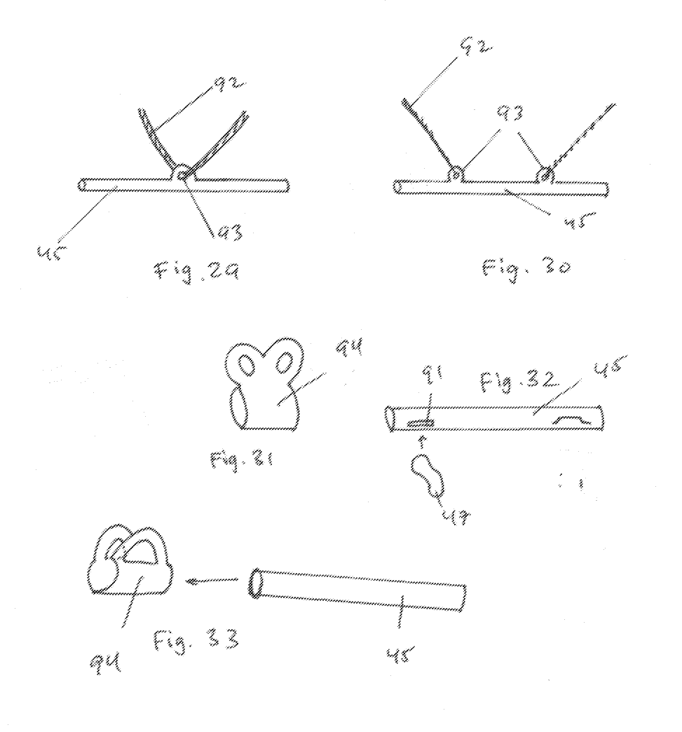

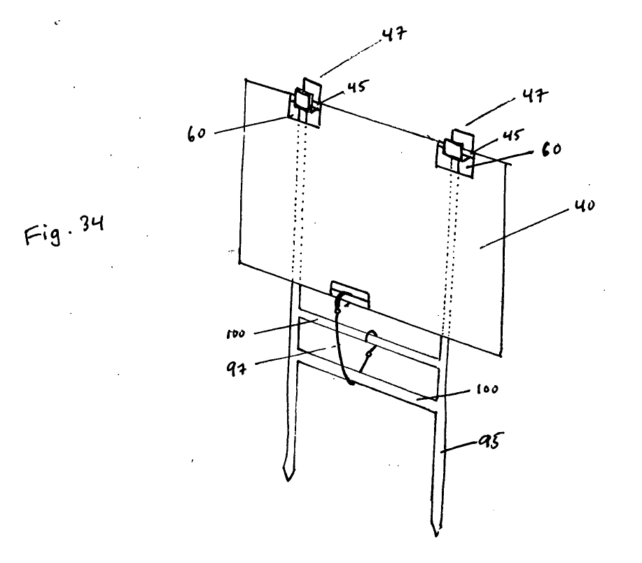

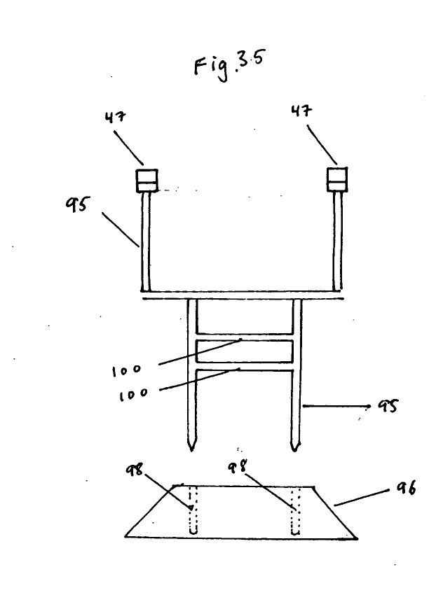

FIG. 3. Is a close up of banner 40 with banner channel 55

FIG. 4. Is a close up of banner 40 with banner channel 55 and banner frame member 55

FIG. 5 is a frontal view of banner 40 with multiple banner openings 60 and one banner channel 55.

FIG. 6 is a frontal view of banner 40 with multiple banner openings 60 and one banner channel 55 and a banner frame member 45.

FIG. 7 is a perspective view of banner 40 with multiple banner openings 60 and one banner channel 55 and a banner frame member 45 with banner member mount 47 with its banner member grip 48

FIG. 8 is a perspective view of banner 40 with multiple banner openings 60 and one banner channel 55 and a banner frame member 45 with two banner member mount 47 being mounted with an elongated Banner Display mounting device

FIG. 9 and FIG. 10 are banners 40 with different banner sleeve 55 openings

FIG. 11 is a rear view of banner tauting system where banner 40 has two banner member mounts 55 and two banner members 55 on opposite ends of said banner 40. There's a perpendicular bracing device 50 with the ability to push both banner frame members 55 apart. The said brace member 50 is attached to the frame members 55 through the banner opening 60.

FIG. 12 is a perspective view of banner tauting system where banner 40 has two banner member mounts 55 and two banner members 55 on opposite ends of said banner 40. There's a perpendicular bracing device 50 with the ability to push both banner frame members 55 apart. The said brace member 50 is attached to the frame members 55 through the banner opening 60. Here two additional banner frame members 46 have been attached to existing banner frame members 45.

FIG. 13 shows one embodiment of a banner member mount 47, with gripper 78 and double sided adhesive 44 which also includes a releasable no stick cover.

FIGS. 14, 15, 16 17a-17c are various embodiments of said banner member mounts 47.

FIG. 19. Shows banner member mounts 47 in use to overcome and window framing 71 to allow the banner 40 to be displaced in contiguous manner on the window 70.

FIG. 20. Is a embodiment of said banner mount where the banner mount member 47, with grippers 78, are attached to car 85 with magnets 87. Also, the banner 40 has magnets 87 to keep banner attached to car 85.

FIG. 21 is a perspective view of a sign mounting device where there's a rigid sign 62 with sign opening 61 which will allow the sign support 63 to attach the sign 62 to the sign member mount 65 and keep it relatively flush against the window 70.

FIGS. 22-24 are different views of Sign Support member 63, Sign Support member coupling section 64, Sign support mount 65, Sign support mount, coupling section 66, Sign Support member release grip 67.

FIG. 25 shows sign 62 attached to car window by sign support mounts 65.

FIG. 26 shows a specific car window 72 with sign member mounts 65 and sale sign with holes 61 being engaged by four sign support mounts

FIG. 27 shows banner 40 with frame member 45 with opening 91 aligned with banner opening 60 and banner mount member mount 47.

FIGS. 29 and 30 show banner frame members 45 with loops 93 to facilitate mounting of rope 92.

FIG. 30 shows attachable banner member loop.

FIG. 31. shows removably attachable frame member mounting facilitators 94

FIG. 32. shows banner member 45 with banner member mount 47 aligned with the banner frame member opening 91

FIG. 33. shows removably attachable frame member mounting facilitator 94 about to engage with the banner member 45

FIG. 34 shows a perspective view of banner 40 attached to the banner display device and support assembly 95 with the two banner opening 60 exposing the banner member 45 mounted to banner member mounts 47. The banner 40 is held taut by the pulling force of the elastic connector 97 securely attached to one of the banner support assembly's several fixed attachment points 100.

FIG. 35 shows a front view of the banner display device and support assembly 95 in FIG. 34, without the banner 40. And also shows one embodiment of the banner display support base 96, where there are holes to accept banner display devices perpendicular vertical members.

The banner display device according to the sign display device and mounting method may be employed either in the vertical orientation shown in the Figures, in a horizontal orientation, or in any other desired orientation, a particular advantage of employing it in the vertical orientation shown is that it is held quite securely in place, once the brace has been mounted, by the force of gravity. In those embodiments of the sign display device and mounting method comprising the retention means described herein, use of the retention means in conjunction with a stop, as described, provides a very secure assembly.

As will appear to those familiar with the art of standard making and banner display, particulars such as the cross sections of the various components described herein are largely immaterial. For example, the support, brace, and frame members may be of circular, square, or other common cross-sectional shape, solid, tubular, or hollow, or of any other section not inconsistent with the purposes described herein. Likewise, while generally preferred embodiments of the sign display device and mounting method are fabricated from metal, wood, or plastic materials, such as steel, aluminum, or polyvinyl chloride (PVC), any materials of sufficient strength, durability, and corrosion-resistant properties for specific applications will serve, the proper selection of such materials being well within the skill of ordinary designer of such systems.

With regard to systems and components above referred to, but not otherwise specified or described in detail herein, the workings and specifications of such systems and components and the manner in which they may be made or assembled or used, both cooperatively with each other and with the other elements of the sign display device and mounting method described herein to effect the purposes herein disclosed, are all believed to be well within the knowledge of those skilled in the art.

No concerted attempt to repeat here what is generally known to the artisan has therefore been made.

### INDUSTRIAL APPLICABILITY

The sign display device and mounting method provides improvements for holding fixtures, and more particularly for banner and sign display devices. In particular, the sign display device and mounting method provides secure simplified means for permanent or temporary mounting and display of banners and other devices. The sign display device and mounting method further provides a system for the interchanging of banners and signs displays on a wide variety of surfaces and objects and also in some embodiments protecting banners from wind damage by the allowing the banner support assembly to respond the wind loads by reducing the effective area of the banner, and to spill the wind.

In compliance with the statute, the sign display device and mounting method has been described in language more or less specific as to structural features. It is to be understood, however, that the sign display device and mounting method is not limited to the specific features shown, since the means and construction shown comprise preferred forms of putting the sign display device and mounting method into effect. The sign display device and mounting method is, therefore, claimed in any of its forms or modifications within the legitimate and valid scope of the appended claims, appropriately interpreted in accordance with the doctrine of equivalents.

1. A banner display and support assembly for holding a banner taut, said banner support assembly comprising
a. a first and a second frame member that hold the banner along its opposite sides;
b. one or more frame members removably attached perpendicularly to said banner frame members in a manner to brace and hold said first and second frame members apart; and
c. a means for tensioning the banner by increasing the distance between the first frame member and the second frame member; and
d. a banner with one or more of its edges folded over to form a channel along one or more sides along its perimeter; and
e. said channel with diameter great enough to accept said frame member; and
f. said channel having one or more openings exposing and providing access to said frame members; and
g. said perpendicular brace comprising: i. a first portion to which the first frame member is engaged; and ii. a second portion to which the second frame member is engaged; and iii. a means within said perpendicular brace to increase the distance between the first and second frame member; and
h. said perpendicular brace members attaching at the area of more said banner perimeter channel openings;
whereby the banner is held taut in the banner support assembly.

2. The banner display and support assembly of claim 1, where one or more of said perpendicular frame members attach to said banner frame members anywhere from the midpoint of said first and second frame members outward to the ends of the said frame members.

3. The banner display and support assembly of claim 1, where the said channel having one or more said openings exposing and providing access to said frame members can be located anywhere along said perimeter.

4. The banner display and support assembly of claim 1, where said channel openings in said banner can be as narrow as slits or as wide as the full diameter of said channel opening.

5. The banner display and support assembly of claim 1, where said channel openings can be as short as one centimeter or as nearly as long as said banner frame members that the banner is attached.

6. (canceled)

7. The banner display and support assembly of claim 1, where said channel openings may be created by, but not limited to: hand cut, machine cut, hand removed or machine removed.

8. (canceled)

9. The banner display and support assembly of claim 1, where said channel openings, are spaced relatively symmetrically, respective to the length of said banner unless the said surface or object requires non-symmetric spacing.

10. The banner display and support assembly of claim 1, where when said channel openings are larger than said perpendicular bracing member engaging in said banner openings.

11. The banner display and support assembly of claim 1, where said perpendicular frame members means of tensioning said banner by increasing the distance between said first frame member and the second frame member may include, but not limited to: a spring, a screw thread, bevel gears, a cam and lever arm, a ratchet with release and a pin and hole system or just the said perpendicular frame member itself.

12. The banner display and support assembly of claim 1, where one or more additional said frame members can be attached to said banner frame members.

13. The banner display and support assembly of claim 12, where said additional frame members comprising: a first portion which is pivotally connected to the said banners' first frame member; and ii. A second portion of which is engaged with the ground or other surface, so said banner frame is kept relatively upright.

14. The banner display and mounting system of claim 1, where said banner frame members may have one or more bends, curves, loops, hooks, holes, openings, recesses or other means to facilitate and greater secure the mounting of said banner to said perpendicular member, banner mount or other stabilizing surface, wall or object.

15. (canceled)

16. The banner display and mounting system of claim 1 where said banner frame members are metal tubing or other rigid elongated material.

17. The banner display and mounting system of claim 14, where said means to facilitate mounting and greater secure said banner member to either said banner member mount or said wall or surface, such as said holes, openings and recesses along said banner may be oriented to align with both said banner channel openings and with said perpendicular banner brace frame member.

18. The banner display and support assembly of claim 14, where said facilitating means of mounting such as loops, hooks may be removably attached to said banner frame before or after said banner frame member has been inserted in said banner channels.

19. The banner display and mounting system of claim 1 where said means to facilitate mounting said banner frame member to said banner mount is oriented to align with both said banner channel openings and with said banner frame are hidden from the perspective of the viewer standing in front of said banner display.

20. The banner display and support assembly of claim 1 where said banner may be any flexible sheet material such as, but not limited to, cotton, cloth, vinyl, nylon, paper or plastic.

21. (canceled)

22. A banner display and mounting system for interchanging banners, said banner mounting system comprising:
a. at least one frame member that holds the banner along one side;
b. one or more frame member mounts with means to attach said banner frame member to desired surface or object;
c. said frame member mounts comprising at least: i. first portion to which attaches to a surface or object, ii. second portion which engages with said banner frame member
d. a banner with one or more of its edges folded over to form a channel along one or more sides along its perimeter; and
e. said perimeter channel with diameter great enough to accept said banner frame member;
f. said perimeter channel having one or more openings exposing and providing access to said banner frame member within said banner perimeter channel; and
g. said frame members mounts attaching to said banner frame members where said banner perimeter channel openings are located.

23. The banner display and mounting system of claim 22 where the said frame member mounts have means to attach to walls, ceilings, glass, poles and vehicles.

24. The banner display and mounting system of claim 23 where the said frame member mounts' means of attaching to said surfaces includes, by not limited to: screws, adhesives, double side adhesive, hook and loop, magnets, glue, fasteners, rope, male-female connectors and other snap-on coupling means or a combination of these.

25. (canceled)

26. The banner display and mounting system of claim 22 where a plurality of said member mounts can be attached to a plurality of said surfaces or objects, therefore allowing a plurality of said banner displays to be mounted, interchangeably, to a plurality of said surfaces and objects.

27-30. (canceled)

31. (canceled)

32. The banner display and mounting system of claim 14 where said facilitating means of mounting such as loops, hooks will allow the user to mount said banner with as few as one connection point.

33-36. (canceled)

37. The banner display and mounting system of claim 22 where said banner can be mounted or dismounted by as few as one person using just his hands.

38-61. (canceled)

62. The banner display and mounting system of claim 22 where the said display device frame members may be curved or angled away from said surface, so that certain areas of said banner frame member, and therefore the said attached banner, are further away from the said surface or object than other sections of the same said banner frame member.

63. The banner display and mounting system of claim 22 where the said banner frame members may be attached to said displays that are both two dimensional and three dimensional, such as an inflatable beer bottle.

64. (canceled)

65. The banner display and mounting system of claim 22 where said banner frame may be attached said banner mounting device before it's attached to the said surface or object.

66. (canceled)

67. The banner display and mounting system of claim 22 where one or more locking or gripping devices are incorporated into or are removably attachable to said frame member mount to increase the hold and security of said display device to said banner frame member.

68. The banner display and mounting system of claim 22 where one or more said banner channels or sleeves may be sealed at their openings with glue, tape, adhesive or sewing during or after the manufacture process to restrict the movement of said banner frame member or pole after said pole has been inserted into said banner sleeve.

69. The banner display and mounting system of claim 22 where one or more said banner openings are reinforced by adding one or more layers of material, such as banner tape, up to the full perimeter of said banner opening.

70-71. (canceled)

72. A banner display device and support assembly for holding a banner taut, said banner support assembly comprising:
a. a first and a second banner frame member that hold the banner along its opposite sides;
b. said first banner frame member removably attached to a banner mount in a manner to hold said first banner frame member perpendicular to the mounting member of said banner display device;
c. said second frame member positioned along lower portion of said banner display device;
d. said banner display device comprising at least: i. a first portion of one or more vertical frame members to which said first banner frame member is mounted; and ii. a second portion adapted to engage said second frame member; iii. a third portion that extends perpendicularly below said second banner frame member; and
e. a connecting member, attached at its first end to the second frame member of the banner and at its second end to one or more fixed points on said display device, to tension the banner by increasing the distance between the first frame member and the second frame member to which the second frame member attached;
whereby, the banner is held taut in the banner support assembly, and the second frame member is able to move and spill wind to limit damage to the banner: and
f. a support base positionable on the ground or other surface for releasable connection to said third portion of said banner display device to support said banner display device above the ground or other surface and maintain said banner display device in a stable, substantially upright condition, said support base having a means of receiving at least one said banner display device frame member, with said means of receiving said banner display device substantially conforming in size and shape to at least one said banner display device frame member received thereby such that at least one said banner device frame member is frictionally engaged by said support base along the length thereof to prevent relative movement between at least one said banner display device member and said support base.

73. (canceled)

74. The banner support of claim 72, where the connecting member is an elastomer material.

75. The banner support of claim 72, where the lower end point of said third portion of said banner display device which extends perpendicular below the said second member of the banner frame member is used as a stake-like device to penetrate dirt, lawns and the like to hold said banner display device in a relative stable upright position.

76. The banner support of claim 72, where the lower end point of said third portion of said banner display device incorporates a foot support to drive said display device more easily into the ground.

77. A Sign Display Device and Mounting Method for quick interchanging of signs comprising:
a. One or more sign support member removably attached to the face of said sign; and
b. one or more support member mounts with means to attach said sign support member to desired surface or object; and
c. said support member mounts comprising at least: i. first portion to which attaches to said desired surface ii. second portion which engages with said sign and its said sign support member; and
d. said sign support member comprising at least: i. first portion to which engages to said sign face ii. second portion which connects with said support member mount; and
e. said sign with one or more sections of its face removed; and
f. said sign face having one or more said openings exposing and providing access to said support members; and
g. said removed sections with area relatively the same size and shape as said support member mount; and
h. said support members mounts coupling with said sign support members where said openings are located; and
i. said sign being sandwiched in between said sign support member and said support member mount;
whereby said sign is held secure in said sign display device on said surface.

78. The sign display device in claim 77, where said support members are relatively symmetrically located on said sign face.

79. The sign display device in claim 77, where said sign support member first portion covers greater surface area and is larger than said sign face opening.

80. (canceled)

81. The sign display device in claim 77, where said sign support member's second or said bottom portion is deep as said sign thickness in order to securely hold said sign and be relatively flush with said sign face and said wall surface.

82. (canceled)

83. (canceled)

84. The sign display device in claim 77, where said sign support member has means to allow the user to remove it quickly and easily from said sign face such as, but not limited to, a handle or other protruding or gripping means.

85.-87. (canceled)

88. The sign display device in claim 77, where said sign, can be shaped in an infinite number of ways, such as a cupcake, pizza, square, human shaped, or shaped to fit any store or vehicle window, car panel or any size and shape of said sign that's capable of having at least one said sign member mount attached.

89.-107. (canceled)

108. The banner display device in claim 72, where said banner support base is permanently or semi-permanently incorporated into said banner displays' design.

109. The banner display device in claim 72, where said support bases' said means of receiving said banner display devices' said mounting member is a hole or recess.
